(19) United States
(12) Patent Application Publication
(10) Pub. No.: US 2026/0123570 A1
(43) Pub. Date: May 7, 2026

(54) DEVICE FOR DISTANCE OR HEIGHT CONTROL AND ATTACHMENT WITH SUCH A DEVICE

(71) Applicant: BAUMER ELECTRIC AG, FRAUENFELD (CH)

(72) Inventors: MICHAEL WEIGEL, SALENSTEIN (CH); RAINER MAUCH, HILZINGEN (DE)

(73) Assignee: BAUMER ELECTRIC AG, FRAUENFELD (CH)

(21) Appl. No.: 19/381,009

(22) Filed: Nov. 6, 2025

(30) Foreign Application Priority Data
Nov. 7, 2024 (DE) 10 2024 132 523.2

(51) Int. Cl. A01C 23/00; A01B 69/04; A01C 23/04; A01D 41/127; A01D 75/00; A01M 7/00

(52) U.S. Cl. CPC A01C 23/007; A01B 69/008; A01C 23/047; A01M 7/0042; A01M 7/0089; A01D 41/127; A01D 75/00

(57) ABSTRACT

A device for controlling a distance and/or a height of an attachment above the ground and/or above a plant surface. The attachment is attached to an agricultural vehicle. The device includes a scanner, an evaluation unit, and a control unit. The scanner detects a plurality of detections, detects a detection area, the detection area being is narrower in the direction of travel than transverse to the direction of travel, and detects objects via the plurality of detections and to record data on a detected angle, a detected distance to an object, and/or a density of the object or the objects. The evaluation unit reproduces a ground profile and/or the plant surface and/or a location-dependent plant density as evaluation data. The control unit processes the evaluation data into control commands and controls the distance and/or the height of the attachment to a target value.

### CROSS REFERENCE TO PRIOR APPLICATIONS

Priority is claimed to German Patent Application No. DE 10 2024 132 523.2, filed Nov. 7, 2024. The entire disclosure of said application is incorporated by reference herein.

### FIELD

The present invention relates to a device for controlling the distance and/or height of an attachment of an agricultural machine and to an attachment.

### BACKGROUND

DE 10 2017 004 808 B3 describes a control device for controlling a height of an attachment with a 1D radar sensor in order to determine the height of the sensor to the ground and/or to a plant and thus to obtain an actual value for the height of the attachment, which is compared with a target value.

The problem with one-dimensional or point-based detection using a conventional 1D radar sensor is that the point-based detection sometimes only detects gaps between the individual plants. This means that the measured values that provide information about the condition of the vegetation are not representative. Crops are often sown or planted in rows. A 1D sensor will in this case be unable to detect the actual plant height in some cases if the 1D sensor is scanning between the rows, i.e., only at the ground or in the area of weeds, or the 1D sensor will move over a protruding plant and assume a higher plant profile to exist than is actually the case. The only remedy is here the use of a very large number of 1D sensors that are distributed across the attachment, which leads to high costs.

### SUMMARY

An aspect of the present invention is to overcome the disadvantages known from the prior art. An aspect of the present invention is in particular to make the agricultural cultivation of plants or soils more precise and economical.

In an embodiment, the present invention provides a device for controlling a distance and/or a height of an attachment above the ground and/or above a plant surface. The attachment is configured to be attached to an agricultural vehicle transversely to a direction of travel of the agricultural vehicle and to treat the ground and/or to treat plants and/or to harvest plants. The device includes a scanner, an evaluation unit, and a control unit. The scanner is configured to detect a plurality of detections, to detect a detection area, the detection area being narrower in the direction of travel than transverse to the direction of travel, to detect objects via the plurality of detections and to record data on a detected angle, and/or a detected distance to an object, and/or a density of the object or the objects. The evaluation unit is configured to reproduce a ground profile and/or the plant surface and/or a location-dependent plant density as evaluation data. The control unit is configured to process the evaluation data into control commands and to control the distance and/or the height of the attachment to a target value.

### BRIEF DESCRIPTION OF THE DRAWINGS

The present invention is described in greater detail below on the basis of embodiments and of the drawings in which:

FIG. 1 shows a schematic representation of a device for distance or height control of an attachment with a 1D sensor according to the prior art;

FIG. 2 shows a schematic representation of a device for distance or height control of an attachment according to the present invention in a plan view;

FIG. 3 shows a schematic representation of the device for adjusting the distance or height of an attachment according to the present invention in a planting system arranged in rows, as in FIG. 2;

FIG. 4 shows a schematic representation of the device for distance or height control of an attachment according to the present invention in dense vegetation with a profile determination;

FIG. 5 shows a schematic representation of the device for distance or height control of an attachment according to the present invention in sparse vegetation with a profile determination;

FIG. 6 shows a schematic representation of the device for distance or height control of an attachment according to the present invention in a transverse view;

FIG. 7 shows that at least one panel antenna comprises four patch elements which are arranged in a row along an X-direction and/or symmetrically to a common straight line, wherein the straight line runs through the center point of the respective patch element;

FIG. 8 shows an arrangement of several transmitter-side panel antennas and several receiver-side panel antennas, which are included in MIMO radar sensors;

FIG. 9 shows a perspective view of an agricultural vehicle with an attachment on which a MIMO radar sensor is mounted so that the detection area in the direction of travel is narrower than transversely to the direction of travel; and

FIG. 10 shows a schematic side view of the attachment with the MIMO radar sensors from FIGS. 7-9 for two different mounting variants.

### DETAILED DESCRIPTION

The device according to the present invention controls the distance and/or height of an implement above the soil and/or plant surface. An aspect of the present invention is thereby to in particular control the optimal distance between the implement and the soil and/or plant surface for the application.

An attachment within the meaning of the present invention is a device which is attached to an agricultural vehicle and which serves as a tool, for example, for working the ground vegetation (e.g., spraying, cutting, harvesting, etc.) or the soil itself. Such a vehicle is in particular a tractor or a combine harvester or another towing vehicle or a trailer for an agricultural towing vehicle or the like.

The attachment can be a boom, i.e., a structure in the form of an arm attached to the vehicle that can expand its working area. Booms can also be side attachments to equipment that protrude significantly from the chassis of the towing vehicle or trailer.

A typical application is spraying extensive vegetation in a field with a so-called field sprayer. A field sprayer is used to achieve the most even and/or targeted distribution possible of herbicides, pesticides, fungicides, fertilizers, and/or metal-containing liquids which is used for crop maintenance in arable farming and vegetable growing.

A sprayer in particular comprises a plurality of nozzles which are arranged adjacent to one another and transversely to the direction of travel. The sprayer further comprises a transverse extension that projects beyond a transverse extension of the vehicle. The plurality of nozzles are evenly distributed along the transverse extension of the sprayer in order to achieve a treatment with herbicides, pesticides, fungicides, fertilizers, and/or metal-containing liquids when spraying the plants in the field, depending on the size and/or location of the plant and/or plant row.

The attachments can also be mounted on the vehicle as a header, front-mounted, or rear-mounted attachment. Combine harvesters, for example, have headers that feature a cutting unit and/or a reel whose height relative to the ground can be adjusted to achieve the best possible harvest.

The present invention provides a precise and effective distribution of the liquid to be applied, for example, with a field sprayer, whereby the present invention makes it possible to overcome various difficulties in applying the liquid:
If the distance between spray nozzles and the plants and/or the soil is too great, a large portion of the applied liquid (chemicals, fertilizers, etc.) will drift away and the plants will not be sufficiently wetted. The application of the liquid will in this case have no effect and/or an uneven effect.
If the distance between the spray nozzles and the plants and/or the soil is too small, only parts of the plants will be treated and even then, no effect, or only an uneven effect, will be achieved.

This effect is amplified because the ground in a field is usually uneven, i.e., a boom rigidly attached to the vehicle is not at the same distance from the ground and/or the plants at every point along the entire width of the boom.

On uneven terrain, the distance between the plants and the boom or attachment is therefore uneven, which, as described above, has a negative impact on the treatment of the plants.

For various reasons, some of which are biological or even static, the plant profile is not always of the same height or density in all areas of the field. In addition to differences in growth from plant to plant, large gaps between rows may also exisst. Grain may lie on the ground as a result of mechanical impact. Weeds may also grow alongside the crops.
Since the field sprayer sprays the liquid at a specific distribution angle, it is generally expected that the plants will be sprayed unevenly due to the irregularities mentioned above. The amount of liquid applied can also depend on the distance of the spray nozzles from the plants.
Wind drift must also be taken into account, which can also cause uneven distribution if the boom is not positioned at the desired distance above the ground and/or the plants.
A similar drift effect can be observed due to the now high working speeds of agricultural vehicles of up to 30 km/h.
Applying liquids across the entire width of the field sprayer boom can be disadvantageous because expensive fertilizers, herbicides, pesticides, etc. are applied over large areas between plant gaps and/or the gaps between plant rows, where they have no effect.

The device according to the present invention is characterized in that it has a scanner for detecting a plurality of detections, the detection range of which is wider transversely to the direction of travel than in the direction of travel.

The scanner can, for example, be configured as a 2D scanner and/or a 3D scanner. In the context of the present invention, a 2D scanner means that an angle and a distance are recorded for each measurement point. In the context of the present invention, a 3D scanner means that two angles and one distance are recorded per measuring point.

A measuring point in this context results from the reflection of a transmitted measuring signal on the ground or the vegetation or an attachment of the attachment and/or vehicle.

It should be noted that in an embodiment of the scanner as, for example, a radar scanner or as a 2D radar scanner or as a 3D radar scanner, a further dimension in the form of speed can be detected in order to further optimize the device for distance or height control in a boom.

In a further development of the present invention, the scanner is further provided with a linear detection area (e.g., with a laser scanner) with the line running perpendicular to the direction of travel, i.e., being wider perpendicular to the direction of travel than in the direction of travel. Such a line represents a two-dimensional profile.

By capturing a larger area along the implement, more data about the respective soil or plant situation is available, so that more measured values are available at a variety of different locations along the implement. The condition of the soil or vegetation can be recorded more accurately. An improved averaging and/or representation of the soil and/or plant profile across the width along the implement is also possible statistically. This allows for a more precise and also for more economical cultivation.

The device according to the present invention also comprises an evaluation unit according to the present invention. The measurement data acquired with the scanner according to the present invention are transmitted to the evaluation unit according to the present invention. The evaluation unit according to the present invention is configured to recreate the soil/ground profile or the plant surface profile from the measurement data and/or to record the location-dependent plant density.

In other words, the data measured with the scanner according to the present invention are forwarded to an evaluation unit according to the present invention in order to determine the ground profile or the plant surface or also the location-dependent plant density.

In contrast to the sensors known from the prior art, which implement a one-dimensional or point-like detection, the surface and its profile are realistically detected by the present invention since a profile of the vegetation, in particular of the rows of plants, is created.

The device according to the present invention also comprises a control unit according to the present invention for processing the evaluation data into control commands and for adjusting the height of the attachment to a setpoint. The setpoint can, for example, be specified externally.

The device according to the present invention for controlling the distance and/or height of an attachment above the ground and/or the plant surface comprises, in summary, in addition to the scanner according to the present invention, also the evaluation unit according to the present invention and the control unit according to the present invention.

In an embodiment of the present invention, the scanner according to the present invention can, for example, be designed as at least one radar sensor. In a radar sensor, radar waves and/or electromagnetic waves are emitted and their echoes are received as reflections. Each reflection forms a measurement point.

Radar waves generally operate in the frequency range from 1 GHz to 300 GHz, for example, at frequencies around 10 GHz, 60 GHz, 77 GHz, and 122 GHz. This allows objects to be located. Echoes occur on the ground, within vegetation, and on the plant surface. A multitude of reflections are thus detected at different distances and angles from the objects in the field of view of the sensor or scanner in each measurement.

Objects can here be plant parts on the top of the vegetation or plant parts on the ground or plant parts between the ground and the top of the vegetation.

Further echoes are caused by multiple reflections in the crop, between the sensor and/or scanner, and parts of the attachment or other machine parts.

Using appropriate filtering and/or other statistical methods and/or signal processing methods known from the state of the art, the ground and plant distance is determined from a large number of echoes, an estimate of plant density is generated, and unwanted detections such as multiple reflections are suppressed. DE 10 2017 004 808 B3 describes methods for detecting ground and plant distance using a 1D scanner or 1D sensor as an example, which methods can be applied analogously to a 2D and/or 3D scanner.

The device according to the present invention for distance or height control basically aims to in particular detect two types of objects, namely, the ground in order to record its profile or the relative height of the attachment above the ground, and the plants in order to determine their relative height to the attachment and/or density.

The radar waves partially penetrate the plants, but are also reflected thereby so as to be detected by the scanner according to the present invention. The signal reflected from the ground is also detected as an additional signal.

In an embodiment of the present invention, modulated continuous wave radars (FMCW-based radars) can, for example, also be used as radar sensors. The frequency is cyclically modulated in the form of a ramp (chirp), and the frequencies between the transmitted and received signals are compared. Signal analysis can be performed, for example, by cross-correlation (convolution) or electrical mixing of the transmitted and received signals. The frequency components can be demodulated using an FFT (Fast Fourier Transformation).

The scanner according to the present invention can, for example, be designed as at least one FMCW-based radar sensor, in particular in the specific embodiment arranged as a MIMO FMCW radar array. The scanner according to the present invention can, for example, be designed as at least one phased array radar.

The scanner emits waves in a three-dimensional space, which is detected and referred to in the present invention as a detection zone. The detection zone is comparable to a lobe shape. Since the detection zone is smaller in the direction of travel than transverse to the direction of travel, the “lobe” can, for example, have an elliptical or approximately elliptical cross-sectional area. This lobe can in practice also have an approximately rectangular cross-section. It is also conceivable in principle for the ellipse or rectangle of the detection zone to be approximately stretched into a line. With respect to the main axis, which runs centrally through the detection zone in the direction of an emitted beam, the detection zone or lobe is then not rotationally symmetrical. The greater the eccentricity ε (where: 0<ε<1), the greater the width over which the scanner can scan the ground. Opening angles α of 30° to 180° transverse to the direction of travel and opening angles β of 1° to 30° in the direction of travel are conceivable.

The detection range alternatively comprises a first opening angle α transverse to the direction of travel of 70° to 120°, and a second opening angle β of 6° to 20° in the direction of travel.

It is in particular also conceivable that the detection area has a first and second opening angle between 30° and 180°.

In a further development, an embodiment of the present invention can, for example, comprise a scanner which is designed as at least one ultrasonic sensor or as an optical time-of-flight (lidar) sensor.

In another version, the detection area is enlarged in the direction of travel to obtain additional information about the crop. The opening angle of the detection area in this case can be 30° to 180° perpendicular to the direction of travel and 30° to 180° in the direction of travel.

In an embodiment of the present invention, several antennas can, for example, be provided in order to cover a larger area at different angles.

In the configuration of the scanner as a radar sensor, a so-called MIMO (Multiple Input Multiple Output) method can, for example, also be used. This method involves arranging a large number of transmitter and receiver antennas in a single plane. The targeted arrangement of the transmitter and receiver antennas distributes the scanner's resources across the desired spatial angles to be scanned. The combinations of transmitter and receiver antennas form a virtual array. Multiple transmitter antennas transmit different signals, while multiple receivers receive the reflected signals.

The transmitter signals are encoded so that they can be distinguished at the receiver. The received signals are compared with the original transmitter signals, and the signals from the individual transmitters are separated from each other using digital signal processing.

Advanced signal processing techniques such as Fast Fourier Transform and special correlation methods can, for example, be used for signal demodulation. The frequency differences of the resulting transmitter and receiver signal combinations are used to calculate the distance and/or speed. The phase differences between receiving antennas also provide information about angle and/or speed. The MIMO method has the advantage of achieving improved spatial resolution due to the enlarged antenna aperture. The method also allows for increased accuracy, multi-target capability, improved beamforming, and adaptive sampling.

This not only allows a larger spatial detection area to be covered, but also provides the required angular functions for a precise positioning in 2 or 3 dimensions (depending on the arrangement of the transmitter and receiver antennas). While the agricultural vehicle is moving, the device according to this embodiment creates a linear and/or area profile of the vegetation and/or a linear and/or area profile of the soil.

Instead of the MIMO method, the application of a classic beam steering (time-shifted or phase-shifted), a phased array method, can also, for example, be used.

When creating a vegetation profile, a two-or three-dimensional fit curve, or a simple connection of the recorded locations, can be calculated or created. Gaps in vegetation can generally also be detected. It is also conceivable to create a vegetation density profile from the determined reflection data.

Once a plant profile has been determined, one embodiment can in particular also be used to control a spray device on a field sprayer in order to individually control the individual spray nozzles depending on the simulated soil profile and/or the plant surface and/or the location-dependent plant density. This provides that only those spray nozzles that are actually located above plants are activated. If one spray nozzle is located predominantly above a gap in the crop or between the rows of plants, this spray nozzle can be selectively switched off. The spray nozzle can, for example, also be controlled depending on the plant density in order to vary the volume flow of the liquid to be applied.

The measured values acquired by the scanner are transmitted to the evaluation unit according to the present invention. The evaluation evaluates the measured values, and generates the evaluation data therefrom. The evaluation data is then forwarded to the control unit to generate a control command.

The control unit then sends control commands, for example, specifying how much liquid should be released by the sprayer at which location while driving across the field, or creates a density map that serves as the basis for future selective fertilization or optimized harvesting.

This function can, however, also be performed by a separate spray control unit included in the device according to the present invention. It is also conceivable that the spray control unit is designed to deactivate individual nozzles of the spray device or field sprayer, provided they are not located above the plants, but rather, for example, between the rows of plants.

In an embodiment of the present invention, the steering or steering action of the vehicle can, for example, also be influenced or co-determined. By sensor-based detection of the row alignment of the plants, the vehicle can be guided according to the rows or gaps between the rows. It can be very difficult for the driver, based solely on their vision and estimation of the vehicle's dimensions, to steer the vehicle or tires between the rows of plants so that the vehicle or tires are guided along the rows of plants without crushing them and/or negatively impacting them.

The position of the nozzles in relation to the rows of plants can additionally be optimized. This not only minimizes damage to the plants, but also improves the treatment of the crop.

The evaluation, control and, if necessary, spray control unit can be designed as a single unit, either as a whole or in any combination:
the evaluation unit together with the control unit, or
the evaluation unit together with the spray control unit, or
the evaluation unit together with the control unit and the spray control unit, or
the control unit together with the spray control unit.

The evaluation unit can, for example, be designed to determine steering angles. The evaluation unit can, for example, be connected to a steering angle control unit via a control line or wirelessly in order to transmit steering commands to influence the direction of travel of the vehicle.

The evaluation unit can therefore, for example, also generate control commands if it is designed as a control unit. It may be advantageous to combine these components compactly into one unit or to implement them as separate components. Various control units can, for example, be connected to the output of the evaluation unit to obtain different control commands for different devices.

The evaluation data can also, for example, be used for other purposes. Using the evaluation data, a mapping unit can, for example, create a map of the crop volume. Such a map can be used for harvesting, plant care planning, or for similar purposes, which can save considerable time and money because the data is collected alongside usual operational processes.

A precise location information may be necessary for location and, above all, mapping purposes in particular for large areas, for example, to determine the plant density or crop volume at a specific location or to plot it on a map. This information can be provided by a position sensor, in particular a GPS receiver, which then transmits the position information to the evaluation unit.

If the attachment is a boom, especially one with a long boom arm, the arm can sometimes sway significantly up and down when moving across a field or other highly uneven ground. This can affect the measurement due to the Doppler effect, in particular distance measurements.

If the acceleration to which this point of the attachment is subjected is known, however, the Doppler effect can be compensated and, for example, the correct position can be calculated. An embodiment of the present invention therefore provides that acceleration sensors are mounted on the boom to enable more precise measurements.

An advantageous design variant enables a predictive detection by increasing the scanner's detection range in the direction of travel. This is particularly advantageous because adjusting the height of the attachment, boom, etc., as well as controlling a spraying device, requires some time to provide that the plants detected by the measurement can actually be treated accordingly. There is otherwise inevitably a delay between the measurement event, which requires an adjustment of the attachment's height, the amount to be sprayed, or the like, and the actual adjustment, in particular at higher tractor speeds. In this design variant, the scanner therefore measures predictively and records a 3D surface profile.

Spray drift detection can also be implemented if the sensor's detection range is increased in the direction of travel. This advantageously reduces or prevents the sprayed liquid from being blown away, thus having no effect, and/or reaching other plants that are not intended to be treated and may even be damaged, by facilitating the detection of spray droplets flying past. Spray drift means that the liquid application is blown away due to an external influence, such as wind. Spray drift detection is based on the detection of echoes caused by the blown-away spray droplets. This allows the liquid application to be adjusted to reduce or completely prevent the proportion of blown-away spray droplets.

A further advantage of the present invention is that the number of sensors can be reduced compared to the previous prior art since a larger area is covered across the width and measurements need not be taken at discrete locations. Such an embodiment thus also allows for cost savings.

In an embodiment, it is also possible to arrange the scanners so that the entire or almost entire area is captured across its width. Embodiments are conceivable in which the capture areas of adjacent scanners overlap in order to actually obtain the most complete image of the surface profile possible.

### EXAMPLE

An embodiment of the present invention is illustrated in the drawings and is explained in greater detail below.

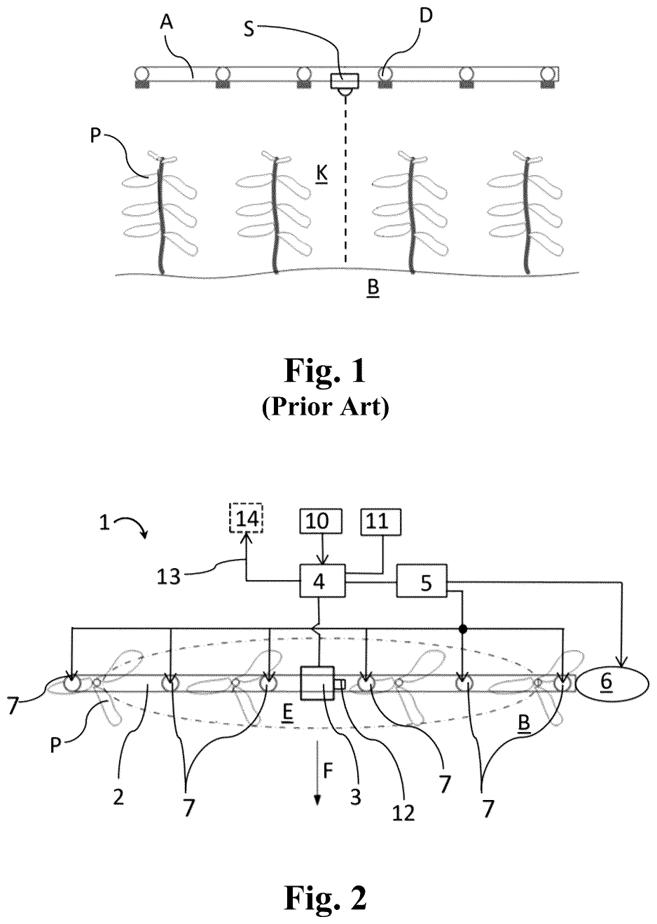

FIG. 1 shows a boom A according to the prior art which is attached to an agricultural vehicle (not shown).

Nozzles D of a field sprayer are attached at regular intervals to this boom A. These are intended to spray plants P cultivated on soil or ground B of a field with a liquid, e.g., a fertilizer or pesticide. The ground B over which the vehicle must travel is generally uneven. It may also happen that the plants P have different heights. In order to spray the plants P as evenly as possible, a 1D sensor S in the form of a radar sensor is attached to the boom A, the signals emitted from which cover an almost linear detection area K.

FIG. 1 illustrates a problem with this state of the art which occurs primarily when the ground B is not very densely covered with plants P. The detection range K is almost a line or a beam, which therefore hits the ground B or a plant P in a point-like manner. The planting P was carried out in rows as shown in FIG. 1, so that a significant distance between the individual rows exists. From above, as seen from a boom A moving over it, the effective density of plants P is comparable to the density of the gaps in between, through which one can see directly onto the ground B. The sensor can in this respect basically hit the ground B just as well as a plant P. Any unevenness in the ground B is difficult to detect due to the narrow detection range K since only a small area is detected.

FIG. 2 shows a device 1 according to the present invention for controlling the distance or height of a boom 2 according to the present invention in a schematic plan view. The boom 2 is designed as a field sprayer and covers several rows of plants P, i.e., the plant arrangement is similar to that in FIG. 1.

Also attached to the boom 2 is a 2D or 3D scanner 3, the detection area E of which, however, has a strongly elliptical and/or approximately rectangular cross-section at the point of impact on the ground B, i.e., in the direction of travel F, the detection area E is generally narrower than perpendicular thereto, i.e., in the direction of the boom 2.

It is also conceivable here that, for example, the ellipse and/or the (approximately) rectangular cross-section of the detection area E is stretched so far toward the boom 2 that it becomes almost linear. The emitted radiation is in practice, however, emitted in the form of a beam with an approximately elliptical cross-section. However, several rows of plants P and, in this case, the gaps between them, are thereby detected.

The measurement data from the 2D or 3D scanner 3 are transmitted to an evaluation unit 4 according to the present invention. The evaluation unit 4 according to the present invention evaluates the measurement data, as described in greater detail below, and forwards the evaluation data thus obtained to the control unit 5 according to the present invention.

In the present embodiment, the control unit 5 according to the present invention essentially has two tasks:
The control unit 5 gives the command to the height adjustment mechanism 6 to, for example, raise or lower the boom 2.
The control unit 5 controls the individually controllable spray nozzles 7 of the field sprayer in order to regulate the amount of liquid depending on the planting, in particular the planting density.

In the present embodiment, the control unit 5 according to the present invention is additionally designed to generate steering angle commands depending on the planting, in particular the planting density. The device 1 according to the present invention therefore comprises a control line 13 for transmitting a signal, in particular a steering angle control signal, to the steering angle control system 14 of the vehicle for automatically guiding the vehicle along the planting rows. The control line 13 can alternatively also be wirelessly connected to the steering angle control system 14 of the vehicle.

In the graphically shown embodiment, the device 1 according to the present invention can, for example, additionally comprises a GPS receiver 10 which forwards the position data to the evaluation unit 4 according to the present invention, which in turn is connected to a mapping unit 11 comprised by the device 1 according to the present invention, which mapping unit 11 is configured to create a map for the distribution and/or recording of the plants P. This map and/or the information recorded therein can be used, in particular during further agricultural processing operations, to optimize the processing of the agricultural land. The mapping unit 11 can, for example, be configured to forward the generated mapping data, for example, wirelessly, directly to a network and/or to a cloud storage device in order to permanently store the data, in particular versioned according to the recording date, and thus make the data available to the farmer.

FIG. 2 also shows that, in the area of the scanner 3, an acceleration sensor 12 is also attached to the boom 2. The acceleration sensor 12 measures the accelerations during up and down movements of the boom 2 while traveling across the field and also transmits these measurement data to the evaluation unit 4 so that the evaluation unit 4 can correct the measured distance values according to this systematic error due to the Doppler effect.

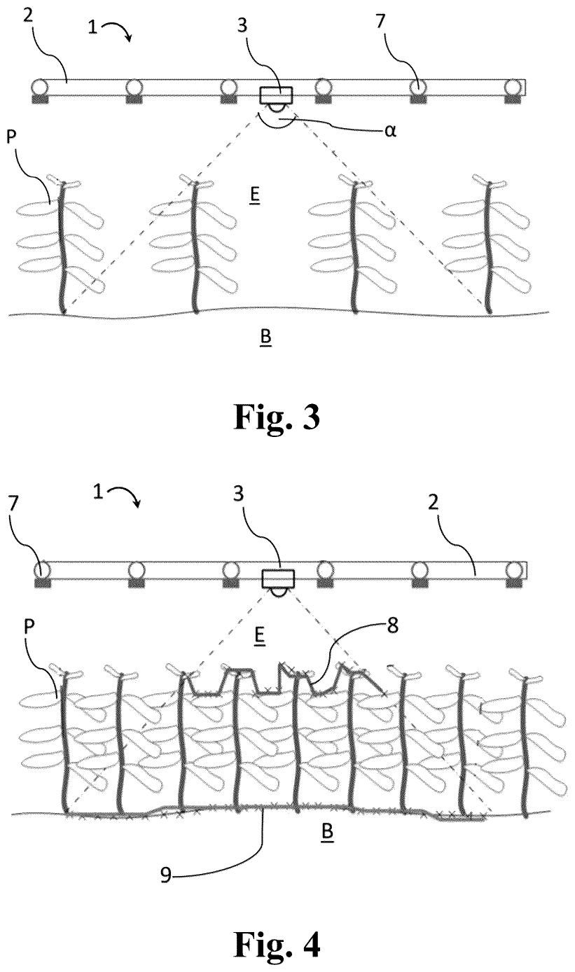

FIG. 3 shows the device 1 according to the present invention (without evaluation and control electronic components 4, 5, 10, 11, 13, 14), already known from FIG. 2, viewed opposite to the direction of travel. As already shown, the detection area E covers several rows of plants P, including the gaps between the rows.

The detection area E has a first opening angle α which is transverse to the direction of travel of substantially 90°. The detection area E also has a second opening angle β of 10° which is aligned along the direction of travel F and is not here illustrated.

FIG. 4 shows the device 1 already known from FIG. 3, wherein the device 1 according to the present invention is now moved over a densely overgrown plant profile 8. The scanner 3, arranged on a boom 2, which is designed as a field sprayer with several spray nozzles 7, transmits radar waves to the detection area E. These radar waves initially strike the leaves and stems of the plants P where a portion of the radar waves is there reflected, and the echo is detected in the scanner 3. Due to free spaces, however, a portion of the transmitted radar waves strikes the ground B and is thus there only reflected. The 2D or 3D measurement data acquired by the scanner 3 are processed in the evaluation unit 4 into a 2D or 3D elevation profile. For the plant profile 8, such a profile is represented by the reference numeral 8, and for the ground/soil by the profile line 9.

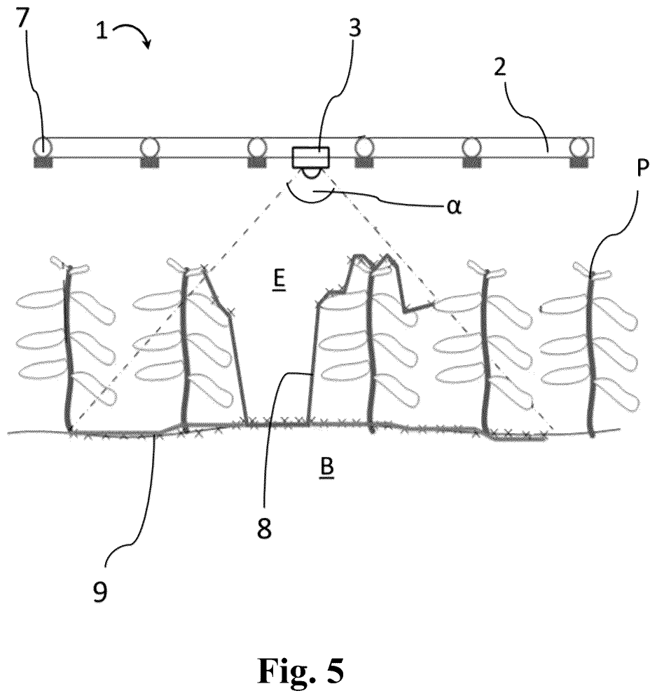

As can be seen from FIG. 5, a plant profile 8 or a ground profile 9 can also be recorded if the density of the plants P is no longer as high as, for example, in the embodiment according to FIG. 4. Larger gaps then lead to the plant profile 8 partially corresponding to the ground profile 9.

What is common to all embodiments and further developments of the present invention is that, in order to enable a particularly precise and economical agricultural processing, the scanner 3 according to the present invention is arranged so that the detection area E is narrower in the direction of travel F than transverse to the direction of travel F, wherein the scanner 3 is designed to detect objects through the respective detections and to record measurement data on the detected angle and/or the detected distance to the object and/or the density of one or more of the objects, wherein an evaluation unit 4 is provided for simulating the ground profile 9 or the plant profile 8 and/or the location-dependent plant density as evaluation data, and a control unit 5 is provided for processing the evaluation data into control commands and for controlling the height of the attachment 2 to a target value. The height control according to the present invention, via the present device 1, provides that a uniform application of liquid can be achieved with a constantly controlled distance between the nozzles and the plant P. Within the scope of the present invention, the liquid application is further optimized by individually controlling and varying the nozzle valve of the individual, adjacent nozzles.

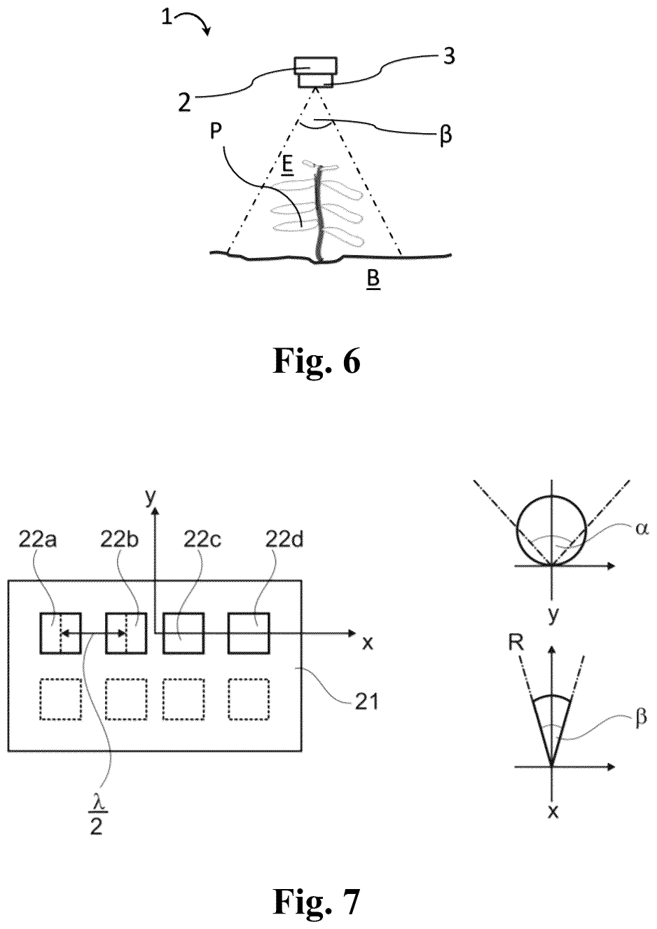

FIG. 6 shows the already known device for distance or height control 1 according to the present invention in a schematic transverse view. The 2D or 3D scanner 3 is also shown in addition to the boom 2, which is here designed as a field sprayer. This view also shows the second opening angle β of the detection area E which is oriented in the direction of travel or along the direction of travel and, in this case, essentially corresponds to 10°.

FIGS. 7-9 refers to a concrete embodiment of a scanner 3 which is designed so that the detection area can be generated according to a lobe shape with a substantially rectangular cross-section.

In the graphically illustrated embodiment, the scanner 3 is designed as a MIMO radar sensor 20 which comprises a detection area in a lobe shape with a substantially rectangular cross-section.

The MIMO radar sensor 20 comprises at least one panel antenna 21 on the receiving side and at least one panel antenna 21 on the transmitting side.

The structure of such a panel antenna 21 is shown as an example in FIG. 7. FIG. 7 shows that the at least one panel antenna 21 comprises four patch elements 22a-d, which are arranged in a row along an X-direction and/or symmetrically to a common straight line, wherein the straight line runs through the center point of the respective patch element 22a-d. From the center point of the respective patch element 22a-d, the distance between two directly adjacent patch elements 22 a-d can, for example, be, λ/ 2, where λ refers to the wavelength of the emitted radar radiation.

The four patch elements 22a-d are also arranged in a common plane. The panel antenna 21 comprises a directional radiation pattern R. The far field aperture angle or opening angle β of the directional pattern along the X direction is smaller than the aperture angle α along the Y direction due to the four patch elements 22a-d adjacent along the X direction. This is evident from the two exemplary radiation patterns labeled X and Y, which graphically represent the radiated intensity R of the antenna over the spatial distribution in a highly schematic manner. In the pattern labeled X, the aperture angle β is therefore smaller than the far field aperture angle or opening angle α in the pattern labeled Y. To limit the directional pattern or the opening angle α along the Y direction, additional rows of patch elements can be added analogously, which is also shown in FIG. 7 by the dotted lines.

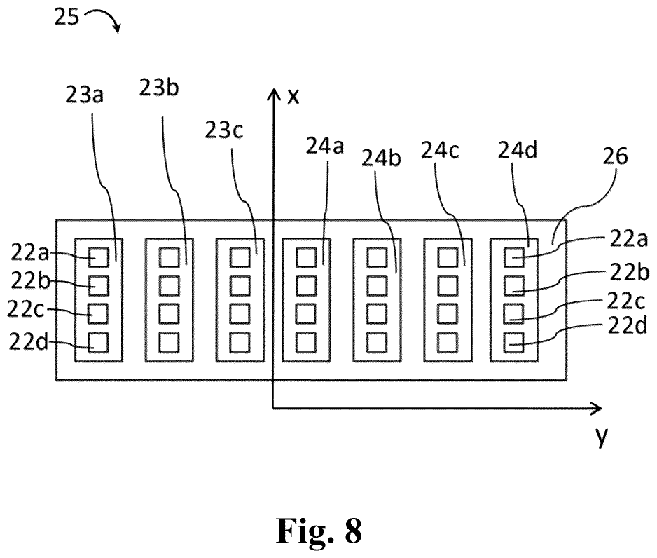

FIG. 8 shows an arrangement of several transmitter-side panel antennas 23a-c and several receiver-side panel antennas 24a-d, which are included in the MIMO radar sensors 20.

In the illustrated embodiment, the antenna arrangement 25 comprises three transmitter-side panel antennas 23a-c and four receiver-side panel antennas 24a-d. The individual panel antennas 23a-c/24a-d are arranged in a common plane and adjacent to one another on a common circuit board 26.

The respective receiving-side panel antenna 24a-d is identical and/or symmetrical to the respective transmitting-side panel antenna 23a-c.

As already mentioned, the individual panel antennas, which transmit or receive radar radiation either on the transmitter side or on the receiver side, each comprise four patch elements 22a-d.

Six or eight patch elements along the x direction can alternatively be provided in each individual panel antenna, with the aperture angle β becoming more restricted with the increasing number of individual patch elements. For example, the aperture angle β is approximately 20° for six adjacent patch elements along the x-direction and approximately 12° for eight patch elements along the x-direction. Depending on the use case, asymmetrical and particularly narrow detection areas can thus be generated by a large number of patch elements arranged in a row, in particular to reduce the proportion of interfering reflections from components of the attachment 2 and/or the agricultural vehicle 100 adjacent in the direction of travel F.

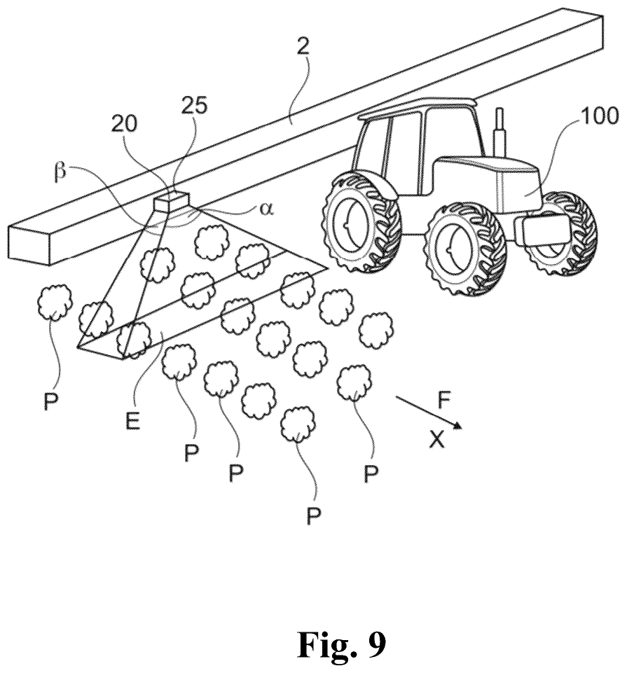

FIG. 9 shows a perspective view of an agricultural vehicle 100 with an attachment 2 on which the MIMO radar sensor 20 is mounted so that the detection area E in the direction of travel F is narrower than transversely to the direction of travel F. With respect to the x-and y-axes according to FIG. 8, this means that the X axis is aligned in the direction of travel F and the Y axis runs transversely to the direction of travel F.

During operation, for example, each of the transmitter-side panel antennas 23a-c and each of the receiver-side panel antennas 24a-d form a transmitter-receiver pair. From the phase differences of transmitter-receiver pairs of adjacent panel antennas, angles can be determined that indicate the position of the detected objects, such as the plants P or the ground B along the Y axis. This information is then processed to determine and adjust the distance using the device 1 according to the present invention for distance and/or height control.

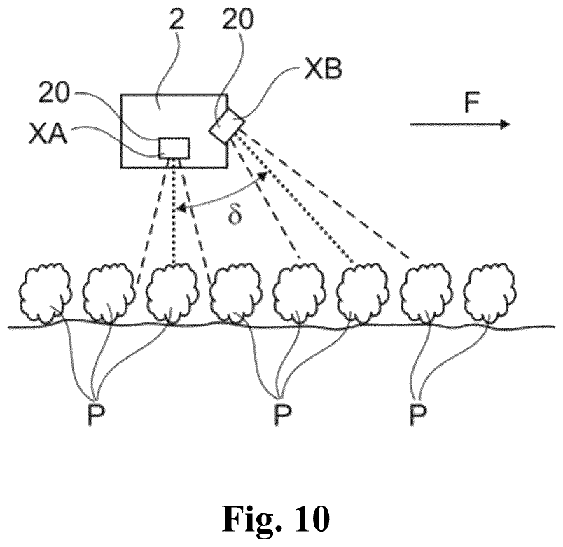

FIG. 10 shows a schematic side view of the attachment 2 with the MIMO radar sensors 20 known from FIGS. 7-9 for two different mounting variants XA and XB. The two alternative mounting variants XA and XB of the MIMO radar sensor 20 shown in FIG. 10 differ in the mounting angle δ in order to align the viewing direction of the MIMO radar sensor 20 either perpendicular to the ground B or obliquely to the ground B and thus inclined in the direction of travel F.

In the XA mounting variant, the viewing direction of the MIMO radar sensor 20 is vertical and is thus aligned towards the plants P and/or the ground B. The width of the detection area along the direction of travel F is here particularly small.

In the XB mounting variant, the viewing direction of the MIMO radar sensor 20 is tilted in the direction of travel F, thus proactively detecting the plants P and/or the soil B, as well as the free space between adjacent rows of plants. In the XB mounting variant, the detection range in the direction of travel F is larger than in the XA mounting variant.

It should lastly be noted that the viewing direction can be inclined at a mounting angle δ between 20° and 40° in the direction of travel. This is advantageous because the reaction time for adjusting the distance of the attachment 2 from the ground B can be increased due to the predictive detection.

The present invention is not limited to embodiments described herein; reference should be had to the appended claims.

### LIST OF REFERENCE CHARACTERS

1 Device (for controlling the distance and/or height of attachment 2)
2 Boom/Attachment
3 2D or 3D sensor
4 Evaluation unit
5 Control unit
6 Height adjustment mechanism
7 Spray nozzles
8 Plant profile
9 Ground profile
10 GPS receiver/Position sensor
11 Mapping unit
12 Acceleration sensor
13 Control line
14 Steering angle control system
20 MIMO radar sensor
21 Panel antenna
22a-d Patch element
23a-d Transmitter-side panel antenna
24a-d Receiver-side panel antenna
25 Antenna arrangement
26 Circuit board
100 Agricultural vehicle
A Boom
B Ground/Soil
D Nozzles (of a field sprayer)
E Detection area
F Direction of travel
K Detection area/Detection range
P Plants
R Directional radar pattern
S 1D sensor
XA First mounting variant of the MIMO radar sensor
XB Second mounting variant of the MIMO radar sensor
α First (larger) opening angle/Opening angle
β Second (smaller) opening angle/Aperture angle
δ mounting angle
ε Eccentricity angle
λ Wavelength of the emitted radar radiation

What is claimed is:

1. A device for controlling a distance and/or a height of an attachment above the ground and/or above a plant surface, wherein,
the attachment is configured to be attached to an agricultural vehicle transversely to a direction of travel of the agricultural vehicle and to treat the ground and/or to treat plants and/or to harvest plants,
the device comprising:
a scanner which is configured,
to detect a plurality of detections,
to detect a detection area,
so that the detection area is narrower in the direction of travel than transverse to the direction of travel, and
to detect objects via the plurality of detections and to record data on,
a detected angle, and/or
a detected distance to an object, and/or
a density of the object or the objects;
an evaluation unit which is configured to reproduce a ground profile and/or the plant surface and/or a location-dependent plant density as evaluation data; and
a control unit which is configured to process the evaluation data into control commands and to control the distance and/or the height of the attachment to a target value.

2. The device as recited in claim 1 wherein the scanner is provided as at least one of:
as at least two 1D radar sensors,
as at least one 2D scanner,
as at least one 3D scanner,
as at least one FMCW-based radar sensor,
as a MIMO FMCW radar array,
as a phased array radar,
as at least one ultrasonic sensor, and
as at least one lidar sensor.

3. The device as recited in claim 1, wherein the scanner is further configured to detect the
detection area in a beam shape with a substantially oval or rectangular cross-sectional area.

4. The device as recited in claim 3, wherein the scanner is further configured so that the detection area has a first opening angle which is transverse to the direction of travel of 30° to 180° and a second opening angle in the direction of travel of 1° to 30°.

5. The device as recited in claim 1, wherein the scanner is further configured to detect the detection area via a MIMO method.

6. The device as recited in claim 5, wherein the scanner comprises:
transmitting and receiving antennas,
wherein,
the transmitting and receiving antennas are arranged in a common mounting plane which is substantially parallel to the ground and/or to the attachment.

7. The device as recited in claim 1, further comprising:
at least one nozzle which is attached to the attachment,
wherein,
the evaluation unit is further configured to transmit the evaluation data at least in part to the control unit, and
the control unit is further configured to control a spraying power of the at least one nozzle.

8. The device as recited in claim 7, further comprising:
a position sensor which is configured to determine a position as position information.

9. The device as recited in claim 8, wherein the position sensor is further configured to forward the position information to the evaluation unit.

10. The device as recited in claim 8, wherein the position sensor is a GPS receiver.

11. The device as recited in claim 7, further comprising:
a separate mapping unit which is connected to the evaluation unit,
wherein,
the evaluation unit is further configured to map at least one of a plant population and a plant density via the evaluation data, or
the separate mapping unit is configured to map at least one of a plant population and a plant density via the evaluation data.

12. An attachment which is configured to be mounted to an agricultural vehicle and to treat at least the ground and/or a plant surface, the attachment comprising:
the device as is recited in claim 1,
wherein,
the device is configured to control the distance and/or the height of the attachment above a ground profile and/or above the plant surface, and the attachment is provided as at least one boom and/or as at least one attachment which is/are configured to be fixed either in front of the agricultural vehicle or behind the agricultural vehicle.

13. The attachment as recited in claim 12, further comprising:
an acceleration sensor which is arranged on the attachment and which is connected to the evaluation unit, the acceleration sensor being configured to compensate for a Doppler effect caused by rapid up and down movements of the attachment.

14. The attachment as recited in claim 13, wherein,
the acceleration sensor is further configured to record acceleration measurement data, and
the acceleration sensor is connected to the evaluation unit and/or to the control unit to transmit the acceleration measurement data which were recorded.

15. The attachment as recited in claim 12, wherein the scanner is partially directed in the direction of travel so as to detect the ground profile and/or the plant surface that has not yet passed during a travel of the agricultural vehicle.

16. The attachment as recited in claim 15, wherein that the scanner is mounted perpendicular to the direction of travel and perpendicular to the ground so as to enable a spray drift detection.

17. The attachment as recited in claim 12, further comprising:
at least one nozzle which is attached to the attachment,
wherein,
the control unit is further configured to control a spraying power of the at least one nozzle individually so that only plants are treated and not gaps in a plant population and/or gaps between rows of the plants.

18. The attachment as recited in claim 12, further comprising:
a control line and/or a wireless connection which is/are configured to transmit a steering angle to the agricultural vehicle,
wherein,
the agricultural vehicle comprises a steering angle control unit which is configured so that the steering angle can be determined by evaluating a position of plant rows and/or gaps between the plant rows so as to guide the agricultural vehicle along the plant rows by intervening in the steering angle.
